(19) United States
(12) Patent Application Publication
(10) Pub. No.: US 2026/0145084 A1
(43) Pub. Date: May 28, 2026

(54) SERVER DEVICE AND INFORMATION PROCESSING DEVICE

(71) Applicant: Sony Interactive Entertainment Inc., Tokyo (JP)

(72) Inventor: Yuki Ikeshita, Kanagawa (JP)

(73) Assignee: Sony Interactive Entertainment Inc., Tokyo (JP)

(21) Appl. No.: 19/446,135

(22) Filed: Jan. 12, 2026

Related U.S. Application Data
(63) Continuation of application No. PCT/JP2023/026010, filed on Jul. 14, 2023.

(51) Int. Cl. A63F 13/795; A63F 13/35; A63F 13/798

(52) U.S. Cl. CPC A63F 13/795; A63F 13/35; A63F 13/798

(57) ABSTRACT

A server device and information processing system are provided for matching users in a gaming environment based on play tendencies. The server device includes one or more processors configured to acquire game start-up and end information from multiple users, thereby identifying the time periods during which each user plays the game. By analyzing these play time periods, the server identifies users whose schedules satisfy a specified overlap relationship, indicating similar play tendencies. The system may notify users of potential matches and refer users as friend candidates based on overlapping play periods, and optionally based on games played or total play time within a defined period. An information processing device is configured to display play tendency information on a profile screen, enabling users to view activity periods and commonly played games. This technology enhances user engagement by facilitating connections between players with compatible gaming habits, improving the overall social experience.

### CROSS-REFERENCES TO RELATED APPLICATIONS

This application is a Continuation Application under 35 U.S.C. 111 of International Application number PCT/JP 2023/026010, filed on Jul. 14, 2023 the entire disclosure of which is incorporated herein by reference for all purposes.

### TECHNICAL FIELD

The present disclosure relates to technology for matching users.

### BACKGROUND

In a gaming system, by forming friendships with specific players, users may exchange information and enjoy the game together. Patent Literature 1 discloses an information processing device that acquires the status of a friend from a server device, and places the image of the friend executing the content around the content icon on the menu screen.

### CITATION LIST

### Patent Literature

Patent Literature 1: Japanese Unexamined Patent Application Publication 2020-098416

### BRIEF SUMMARY

### Technical Problem

It will be possible for users to have a more enjoyable time by forming friendships with players who have similar playing tendencies. The present disclosure is therefore intended to provide technology for searching out players with similar playing tendencies to the user.

According to one embodiments, a server device that includes one or more processors configured to collect information when multiple users start and end a game, determine each user's play time periods from this information, and identify at least two users whose play times meet a particular relationship. The server may notify users when their play times match in a certain way, and may refer one user to another as a potential friend. It also determines which games each user has played and notifies users if their played games meet a certain relationship, such as playing the same game. The server calculates the total play time for each user over a week and notifies users if their weekly play times meet a defined condition. Additionally, the server collects operation data from input devices associated with users and stores the game start and end information in a memory unit linked to each user's account. The relationship between play times may be defined by a threshold for overlapping play periods between two users. The server determines the probability that a user will play during specific time slots based on past activity, and calculates these probabilities over analysis periods that span multiple weeks. It identifies which specific game titles users played during their play periods, and checks if two users played the same titles during overlapping times. The server determines game genres played and notifies users whose play times and genres match, and it regularly updates play time and trend information as new data is collected. Users may customize privacy settings for sharing their play tendencies on profile screens. The server also supports matching and notifications for groups or communities of users based on collective play trends, and it provides recommendations to users for joining groups or participating in community events based on matched play times.

According to another embodiment, an associated information processing device includes processors that collect a user's play trend information, generated from their past game start and end data, and display this information on a profile screen. The display may include the periods during which the user typically plays. The profile screen may also display which games the user plays most frequently and highlight any achievements or virtual rewards the user has earned during gameplay.

### Solution to Problem

The server device according to a certain aspect of the present disclosure includes one or more processors having hardware. One or more processors acquires the game start-up information indicating that a plurality of users have launched a game, along with acquiring the game end information indicating that a plurality of users have terminated the game, and use past game start-up information and game end information to identify the playing time periods of gameplay by each of the plurality of users, thus identifying two users for whom the mutual playing time periods satisfy a first relationship.

The information processing device of another aspect of the present disclosure includes one or more processors having hardware. One or more processors acquires information on the user's playing tendencies, as generated using the past game start-up information and game end information, to display a profile screen including the play tendency information. The play tendency information includes information indicating time periods in which the user plays the game.

It should be noted that any combination of the above-noted components, as well as conversions of the expression of the present disclosure between a method, a device, a system, a computer program, or a recording medium on which the computer program has been recorded, etc., are also valid as aspects of the present disclosure.

### BRIEF DESCRIPTION OF THE DRAWINGS

FIG. 1 is a diagram illustrating the information processing system according to an embodiment.

FIG. 2 is a diagram illustrating the hardware configuration of the information processing device.

FIG. 3 is a diagram illustrating a functional block of the information processing device.

FIG. 4 is a diagram illustrating a functional block of the server device.

FIG. 5 is a diagram illustrating an example of the date and time at which the user played the game.

FIG. 6 is a diagram illustrating an example of the time period in which the user played the game.

FIG. 7 is a diagram illustrating an example of the time period in which the user played the game.

FIG. 8 is a diagram showing the time period during which the user's probability of playing the game is greater than or equal to a predetermined value.

FIG. 9 is a diagram illustrating an example of the playing time period for the user.

FIG. 10 is a diagram illustrating an example of the playing time period for the user.

FIG. 11 is a diagram illustrating an example of the playing time period for the user.

FIG. 12 is a diagram illustrating an example of the profile screen.

### DETAILED DESCRIPTION

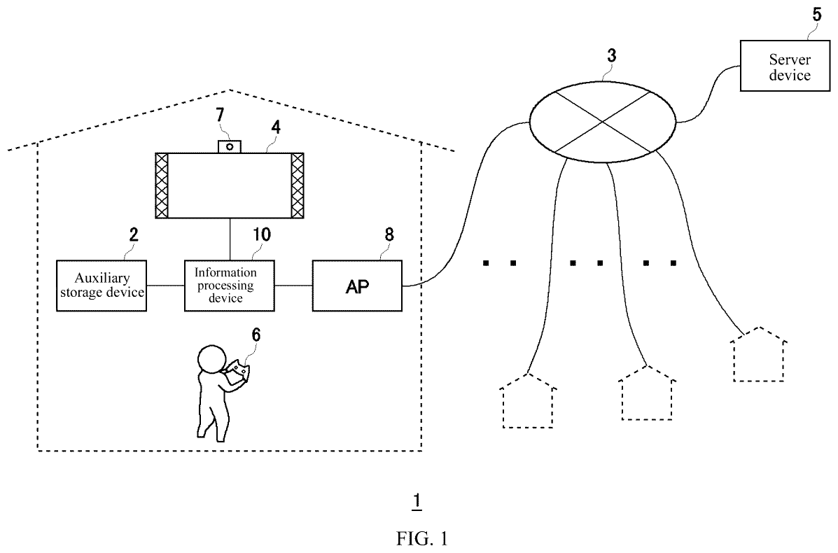

FIG. 1 illustrates an information processing system 1 according to an embodiment of the present disclosure. Information processing system 1 in an embodiment is a gaming system with which a user plays games, and the system includes an information processing device 10 operated by the user and a server device 5. An access point (hereinafter referred to as “AP”) 8 has the function of a wireless access point and a router, and information processing device 10 may be connected to AP 8 wirelessly or using wires to enable communications with server device 5 on a network 3. Although FIG. 1 shows a single user and a single information processing device 10, information processing system 1 assumes that a plurality of information processing devices 10 that may be operated by a plurality of users are connected via network 3 with server device 5.

Information processing device 10 may be connected wirelessly or via wires with an input device 6 to be operated by a user, and input device 6 outputs the operation information by the user to information processing device 10. When information processing device 10 receives operation information from input device 6, it reflects this information in the processing of the system software and game software, and outputs the processing results from an output device 4. In information processing system 1, information processing device 10 may be a game device (game console) for executing games, while input device 6 may be a device such as a game controller that supplies user operation information to information processing device 10. Input device 6 may be an input interface such as a keyboard or mouse.

An auxiliary storage device 2 may be a large capacity recording device, such as a HDD (hard disk drive) or a SS (solid state drive), or it may be an internal recording device, or it may be an external recording device connected to information processing device 10, such as by USB (Universal Serial Bus). Output device 4 may be a television having a display to output images and speakers to output sounds. Output device 4 may be connected to information processing device 10 by wired cables, or it may be wirelessly connected.

A camera 7, which is an imaging device, may be provided in the vicinity of output device 4 in order to image the space around output device 4. While FIG. 1 shows an example of camera 7 mounted on top of output device 4, it may also be positioned on the side or bottom of output device 4, or it may be positioned in any position that allows the imaging of the user positioned in front of output device 4. Camera 7 may be a stereo camera.

Server device 5 provides network services to the users of information processing system 1. Server device 5 manages the network account (user account) that identifies each user, and each user uses the network account to sign in to the network service provided by server device 5. By signing in to the network service from information processing device 10, the user may register the saved data of the game and the virtual reward trophies that were acquired during the game play to server device 5. By registering the saved data and trophies in server device 5, the user may synchronize the saved data and trophies even when using an information processing device that is separate from information processing device 10.

In information processing system 1, a user may form a friendship with another user (player). The user may send a friend request to another user and, if the other user permits the friend request, the first user and the other user may become friends. Server device 5 manages the friends for each user. Users may freely exchange messages with friends and play games together.

Server device 5 of the example of embodiment acquires information about the start and end of a game from a plurality of information processing devices 10. More specifically, server device 5 acquires the game start-up information indicating that a user has launched a game, and the game end information indicating that the user has terminated the game. Upon launching a game, information processing device 10 will generate game start-up information including information identifying the game (game ID) and information indicating the time of the launching of the game (time stamp) for transmission to server device 5. Further, upon the termination of the game, information processing device 10 generates game end information including information identifying the game (game ID) and information indicating the time of the termination of the game (time stamp) for transmission to server device 5. By acquiring the game start-up information and the game end information, server device 5 may determine the time over which the user played the game.

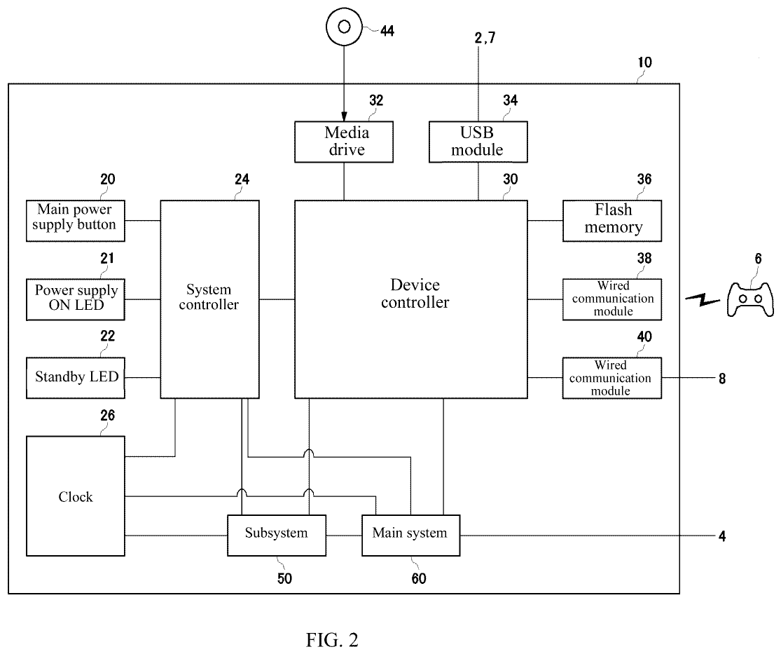

FIG. 2 illustrates a hardware configuration of information processing device 10. Information processing device 10 is formed of a main power supply button 20, a power supply ON LED 21, a standby LED 22, a system controller 24, a clock 26, a device controller 30, a media drive 32, a USB module 34, a flash memory 36, a wireless communication module 38, a wired communication module 40, a subsystem 50, and a main system 60.

Main system 60 may be provided with a main CPU (Central Processing Unit), a memory and memory controller constituting a primary storage device, a GPU (Graphics Processing Unit), and the like. The GPU may be used mainly for arithmetic processing of game programs. The main CPU has functions to launch the system software and to execute the game program installed on auxiliary storage device 2 in the environment provided by the system software. Subsystem 50 may be provided with a sub-CPU and a memory and memory controller constituting a primary storage device, and the like, but it does not include a GPU. The subsystem 50, equipped with a sub-CPU and memory, may manage background data transmission and synchronization tasks, while the main system 60, featuring a primary CPU and GPU, may execute game programs and rendering graphics, according to at least some examples.

While the main CPU has the function to execute a game program installed on auxiliary storage device 2, the sub-CPU does not include such a function. However, the sub-CPU has the function to access auxiliary storage device 2, and to transmit and receive data to and from server device 5. The sub-CPU is configured with only such limited processing functions, and therefore, it may operate at lower power consumption compared to the main CPU. The functions of these sub-CPUs may be executed when the main CPU is in the standby state.

Main power supply button 20 is an input unit in which the operation input of the user may be performed, and it may be provided on a front surface of a housing of information processing device 10 such that it may be operated to turn on or turn off the power supply to main system 60 of information processing device 10. Power ON LED 21 is illuminated when main power supply button 20 has been switched ON, while standby LED 22 is illuminated when main power supply button 20 has been switched OFF. System controller 24 detects the depression of main power supply button 20 by the user.

Clock 26 is a real-time clock, and it generates and supplies the current date and time information to system controller 24, subsystem 50, and main system 60.

Device controller 30 is configured as an LSI (Large-Scale Integrated Circuit) that executes the transfer of information between devices in the same manner as a south-bridge. As shown in the diagram, devices such as system controller 24, media drive 32, USB module 34, flash memory 36, wireless communication module 38, wired communication module 40, subsystem 50, and main system 60 may be connected to device controller 30. Device controller 30 absorbs differences in the electrical characteristics or differences in the data transfer rates of each device, thereby controlling the timing of data transfer.

Media drive 32 is a drive device that includes and drives ROM medium 44 onto which application software such as games and license information have been recorded, and it may also read out programs and data from ROM medium 44. ROM medium 44 is a read-only recording medium such as an optical disc, magneto-optical disc, or Blu-ray disc.

USB module 34 is a module that connects an external device using a USB cable. USB module 34 may be connected to auxiliary storage device 2 and camera 7 via a USB cable. Flash memory 36 is an auxiliary storage device that constitutes internal storage. Wireless communication module 38 may wirelessly communicate with, for example, input device 6 using communication protocols such as Bluetooth (registered trademark) protocol or IEEE 802.11 protocol. Wired communication module 40 communicates with external devices via wired communication, and may be connected to network 3, for example, AP 8.

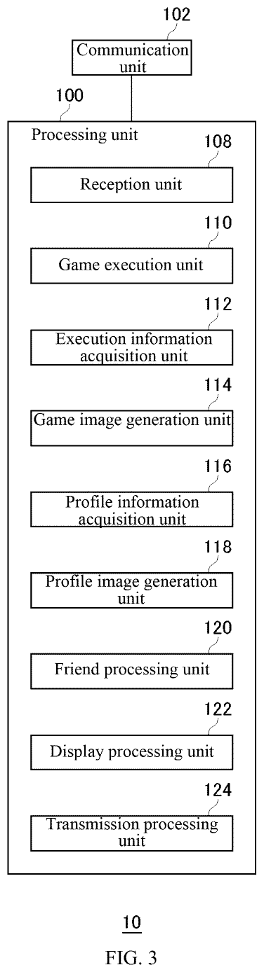

FIG. 3 shows a functional block of information processing device 10. Information processing device 10 includes processing unit 100 and communication unit 102. Processing unit 100 includes reception unit 108, game execution unit 110, execution information acquisition unit 112, game image generation unit 114, profile information acquisition unit 116, profile image generation unit 118, friend processing unit 120, display processing unit 122, and transmission processing unit 124. Reception unit 108 receives information that the user has operated input device 6.

Information processing device 10 includes a computer, which executes a program to realize the various functions shown in FIG. 3. The computer may be provided with memory for loading the programs, one or more processors for executing the loaded program, auxiliary storage devices, other LSIs, and the like as hardware. The processor may be constructed of a plurality of electronic circuits, including semiconductor integrated circuits or LSIs, wherein this plurality of electronic circuits may be mounted on a single chip or may be mounted on a plurality of chips. It will be understood by those skilled in the art that the functional blocks shown in FIG. 3 may be realized through the cooperation of hardware with software, and therefore, may be realized in various ways using hardware alone, software alone, or a combination thereof.

Game execution unit 110 launches and executes the game program. Upon launching the game, game execution unit 110 outputs the game start-up information to execution information acquisition unit 112 indicating that the game has been launched. The game start-up information includes information that identifies the game (game ID) and information that indicates when the game was launched (time stamp). The game start-up information may be generated by the system software, but it may also be generated by the game program. When execution information acquisition unit 112 obtains the game start-up information, transmission processing unit 124 sends the game start-up information to server device 5.

The game program performs arithmetic processing to move the game characters within the virtual space based on the operation information received by reception unit 108. Game image generation unit 114 includes a GPU (Graphics Processing Unit) that performs rendering processing, etc., in order to generate the image data for the game, while display processing unit 122 outputs the game images that were generated from output device 4. Processing unit 100 includes a game sound generation unit that generates the game sound data, but this component is omitted from FIG. 3.

When game execution unit 110 terminates the game that was launched, it outputs the game end information to execution information acquisition unit 112 indicating that the game has been terminated. The game end information includes information that identifies the game (game ID) and information that indicates when the game was terminated (time stamp). The game end information may be generated by the system software, but it may also be generated by the game program. When execution information acquisition unit 112 acquires the game end information, transmission processing unit 124 sends the game end information to server device 5.

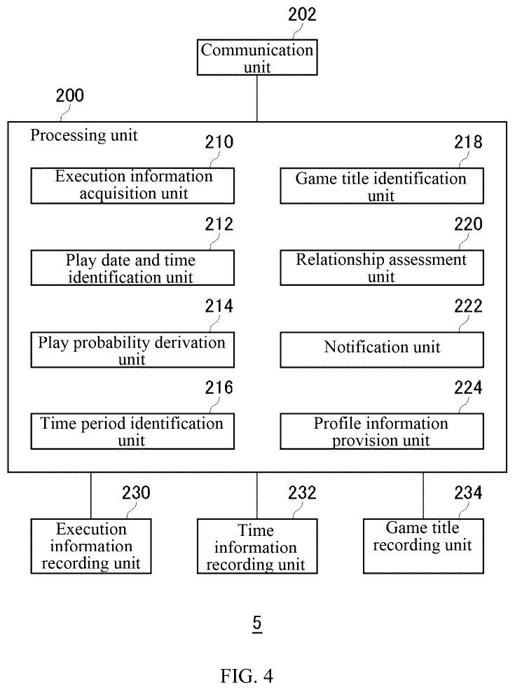

FIG. 4 illustrates a functional block of server device 5 according to an embodiment. Server device 5 includes processing unit 200, communication unit 202, execution information recording unit 230, time information recording unit 232, and game title recording unit 234. Processing unit 200 includes execution information acquisition unit 210, play date and time identification unit 212, play probability derivation unit 214, time period identification unit 216, game title identification unit 218, relationship assessment unit 220, notification unit 222, and profile information provision unit 224.

Server device 5 includes a computer that executes programs in order to realize the various functions shown in FIG. 4. The computer includes memory for loading the programs, one or more processors for executing the loaded program, auxiliary storage devices, other LSIs, and the like as hardware. The processor may be formed of a plurality of electronic circuits, including semiconductor integrated circuits or LSIs, wherein this plurality of electronic circuits may be mounted on a single chip or may be mounted on a plurality of chips. It will be understood by those skilled in the art that the functional blocks shown in FIG. 4 may be realized through the cooperation of hardware with software, and therefore, may be realized in various ways using hardware alone, software alone, or a combination thereof.

Execution information acquisition unit 210 obtains the game start-up information from the plurality of information processing devices 10 indicating that a plurality of users have launched the game. Execution information acquisition unit 210 links the game start-up information that was acquired to the user account and records this information in execution information recording unit 230. Execution information acquisition unit 210 also obtains the game end information indicating that a plurality of users have terminated the game from the plurality of information processing devices 10. Execution information acquisition unit 210 links the acquired game end information to the user account and records this information in execution information recording unit 230.

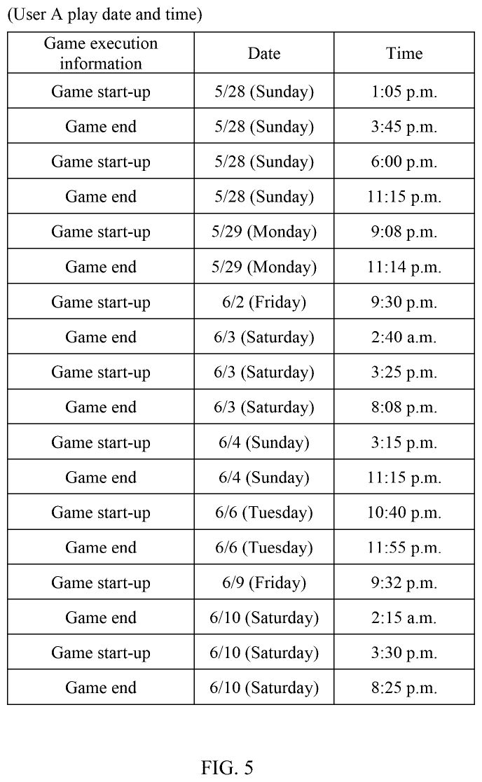

FIG. 5 shows an example of the date and time at which User A played a game. Play date and time identification unit 212 retrieves the game start-up information and game end information of User A that were recorded in execution information recording unit 230 in order to identify the previous play start date and time and the play end date and time of User A. FIG. 5 shows, by way of example, the date and time of the start of the game (play start date and time) and the game end date and time (play end date and time) of User A over the past two weeks.

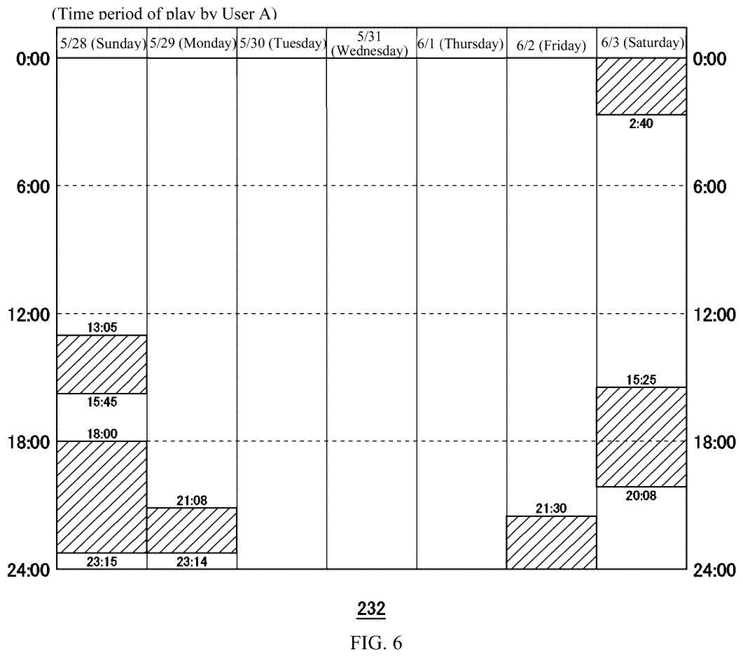

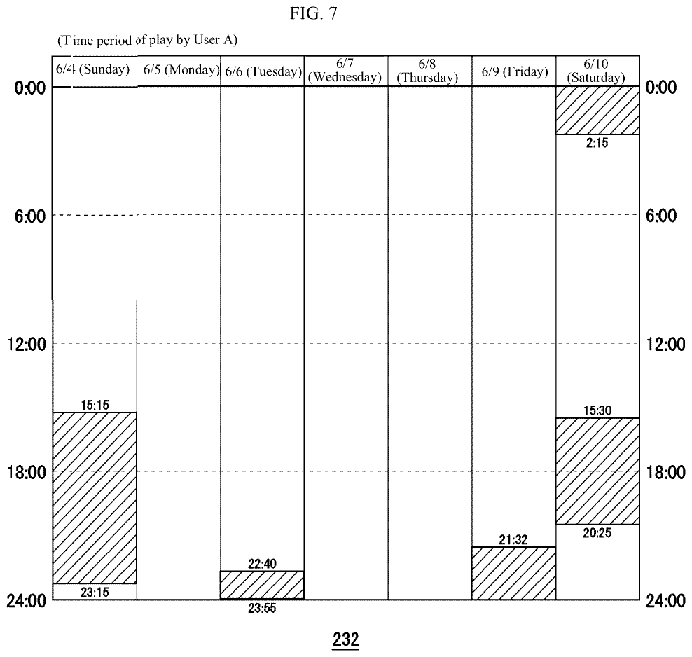

FIG. 6 shows the time period during which User A played the game between 5/28 (Sunday) and 6/3 (Saturday), while FIG. 7 shows the time period during which User A played the game between 6/4 (Sunday) and 6/10 (Saturday). In FIGS. 6 and 7, the regions indicated by hatching show the time periods during which the game was played by User A. In this example, play date and time identification section 212 is referring to the last two weeks of playing time, but by referring to the play date and time for the most recent past 10-week period, it is also acceptable to specify the time period during which User A played the game during the past 10 weeks. Play date and time identification unit 212 identifies the time period during which User A played the game during the past 10 weeks, links it to the user account of User A, and records this information in time information recording unit 232.

Play probability derivation unit 214 derives the probability that User A played the game at the same time on the same day of the week in the past. For example, when looking at 1:59 p.m. on Sunday, User A played the game at 1:59 p.m. on 5/28 (Sunday) (see FIG. 6), but not at 1:59 p.m. on 6/4 (Sunday) (see FIG. 7). Play probability derivation unit 214 refers to the time period during which the game was played by User A in order to determine the number of times that User A played the game at 1:59 p.m. on a Sunday during the past 10 weeks. For example, if User A has played the game six times at 1:59 p.m. on Sunday during the past 10 weeks, play probability derivation unit 214 derives a 60% chance that User A will play the game at 1:59 p.m. on Sunday. In some embodiments, the play probability for each time slot is determined by dividing the number of times a user played during that slot by the total number of periods analyzed (e.g., over 10 weeks). This allows the system to identify periods of high likelihood for user activity.

For example, if a user has played the game seven times at 2:00 p.m. on a Sunday during the past 10 weeks, there is a 70% chance that the user will play the game at 2:00 p.m. on a Sunday, while if the user has played a game eight times at 3:00 p.m. on a Sunday, there is an 80% chance that the user will play the game at 3:00 p.m. on a Sunday. Play probability derivation unit 214 links to User A's user account and records the play probability at each time of the week in time information recording unit 232. In the example of embodiment, play probability derivation unit 214 derives the play probability per minute, but it is also acceptable to derive the play probability per predetermined time period, for example, the play probability per five minutes.

Time period identification unit 216 refers to the play probability recorded for each predetermined time in time information recording unit 232 in order to identify time periods for which the play probability is greater than or equal to the predetermined probability (such as 70%).

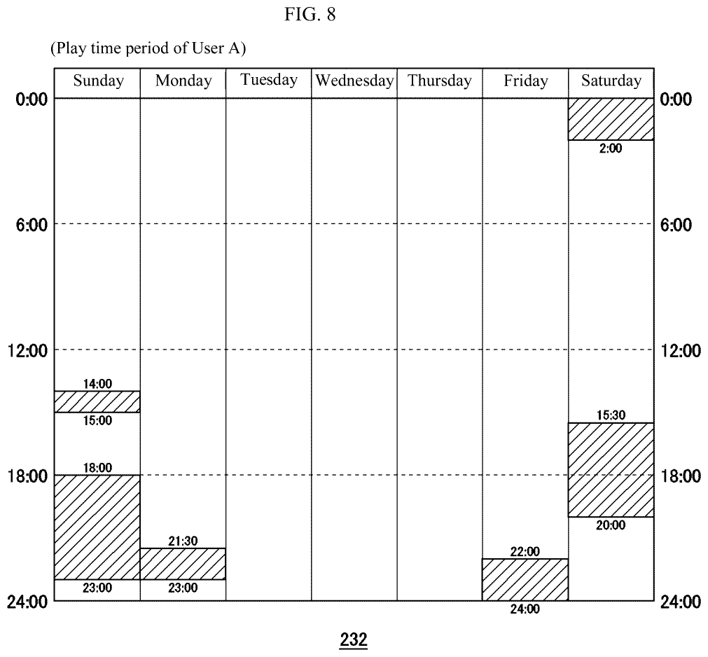

FIG. 8 shows the time periods for which the probability of User A playing the game is 70% or more. In this example, the time periods for which the probability of User A playing the game is 70% or higher are identified as Sunday from 2:00 p.m. to 3:00 p.m., Sunday from 6:00 p.m. to 11:00 p.m., Monday from 9:30 p.m. to 11:00 p.m., Friday from 10:00 p.m. to 12:00 a.m., Saturday from 12:00 a.m. to 2:00 a.m., and Saturday from 3:30 p.m. to 8:00 p.m. In another example of embodiment, time period identification unit 216 identifies a time period with a play probability of 70% or more, but it may also identify time periods with a play probability of 60% or more, for example, or it may identify time periods with a play probability of 80% or more. Time period identification unit 216 links a time period (hereinafter referred to as the “play time period”) for which the play probability is greater than or equal to a predetermined probability to User A's user account, and records this information in time information recording unit 232. This play time period refers to the time period during which User A is relatively likely to play the game.

Time period identification unit 216 sums the hours of the play time period for a one-week period.

The following shows the time for each play time period.
Sunday from 2:00 p.m. to 3:00 p.m. 1 hour
Sunday from 6:00 p.m. to 11:00 p.m. 5 hours
Monday from 9:30 p.m. to 11:00 p.m. 1 hour 30 minutes
Friday from 10:00 p.m. to 12:00 a.m. 2 hours
Saturday from 12:00 a.m. to 2:00 a.m. 2 hours
Saturday from 3:30 p.m. to 8:00 p.m. 4 hours 30 minutes
Therefore, the total time of the play time period for this one-week period is “16 hours.” Time period identification unit 216 links the total time of User A's weekly play time period to User A's user account, and records this information in time information recording unit 232.

Above, the method of identifying User A's play time period and total time thereof was described, and time period identification unit 216 identifies the play time period and total time for each of the multiple users signing into the network service to play the game, and records this information in time information recording unit 232 following linkage with the respective user account.

Game title identification unit 218 identifies the title of the game that the user has played during the play time period during the past 10 weeks. When treating the total time of the play time period in a one-week period as T, game title identification unit 218 may also identify the title of the game that was played for “2 T” hours or longer in the play time period during the past 10 weeks (where the total time will be 10 T). In the example of User A, because T is 16 hours, the title of the game that was played for 32 hours (=2T) or longer in the play time period during the last 10 weeks may be identified.

For example, User A played the title “Fighter2” for “5 T” hours, “Warship4” for “4 T” hours, and “Adventure3” for “1 T” hour. At this time, game title identification unit 218 identifies the title “Fighter2” and the title “Warship4”, which were both played for “2 T” hours or longer, and links the identified game titles to the user account of User A, recording this information in game title recording unit 234.

In this way, game title identification section 218 identifies the title of the games that each of the plurality of users signed into the network service played during the play time period during the past 10 weeks, and links this information to the respective user account, recording this information in game title recording unit 234.

As a result, the total time of each user's weekly play time, the total time of the play time period for a one-week period, and the game titles of the games that were played may be identified. The play time period, the total time of the play time period, and/or the game title (e.g., such as common game titles played by the user) demonstrate a user's play tendencies, and therefore, this information may be referred to below as the “play tendency information.” The play tendency information may be provided to information processing device 10 as information indicative of the user's play tendencies. In the example of embodiment, profile information provision unit 224 provides the respective user's play tendency information to the respective information processing device 10 as part of the profile information for that user.

Relationship assessment unit 220 uses the play tendency information to determine relationships between users. More specifically, relationship assessment unit 220 determines whether the play tendency information of any two users satisfies the predetermined relationship and identifies the two users satisfying the predetermined relationship. In the example of embodiment, if the predetermined relationship of the play tendency information of two users is satisfied, it means that the play tendencies of both users are similar. Therefore, by communicating information about the other user to at least one of such two users, it will be possible to support two users to become friends.

Relationship assessment unit 220 identifies two users whose play time periods satisfy the first relationship. The first relationship may be a relationship in which the overlap rate of the two play time periods is greater than or equal to a predetermined value. For example, the first relationship may be defined as an overlap rate of the play time periods between two users exceeding a predetermined threshold, such as 75%. As shown in Cases 2 and 3 below, the percentage of User A's play time period overlaps with User B's play time period, and the percentage of User B's play time period overlaps with User A's play time period will be equal if the total time of the two play time periods is the same, but if the total time of the play time period is different, the ratio of the two will be different.

### (Case 1)

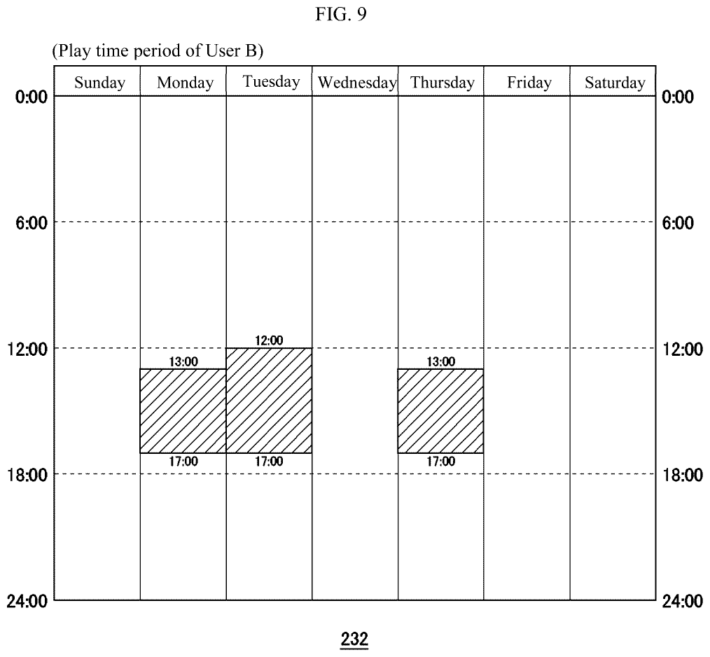

FIG. 9 shows an example of the play time period of User B. In this example, User B's play time is identified as Monday from 1:00 p.m. to 5:00 p.m., Tuesday from 12:00 p.m. to 5:00 p.m., and Thursday from 1:00 p.m. to 5:00 p.m. Time period identification unit 216 links the identified play time periods to the user account of User B, and records this information in time information recording unit 232.

Time period identification part 216 sums the hours of the play time period for a one-week period.

The following shows the time for each play time period.
Monday from 1:00 p.m. to 5:00 p.m. 4 hours
Tuesday from 12:00 p.m. to 5:00 p.m. 5 hours
Thursday from 1:00 p.m. to 5:00 p.m. 4 hours
Therefore, the total time of the play time period for this one-week period is “13 hours.” Time period identification unit 216 links the total time of User B's weekly play time period to User B's user account, and records this information in time information recording unit 232.

Relationship assessment unit 220 derives the overlap rate of the play time period based on the play time period of User A and the play time period of User B. Referring to the play time period of User A shown in FIG. 8 (hereinafter referred to as “Play time period A”) and the play time period of User B shown in FIG. 9 (hereinafter referred to as “Play time period B”), it is clear that Play time period A and Play time period B do not overlap at all. Therefore, the percentage of Play time period A that overlaps with Play time period B and the percentage of Play time period B that overlaps with Play time period A are both 0%, and relationship assessment unit 220 determines that Play time period A and Play time period B do not satisfy the first relationship.

### (Case 2)

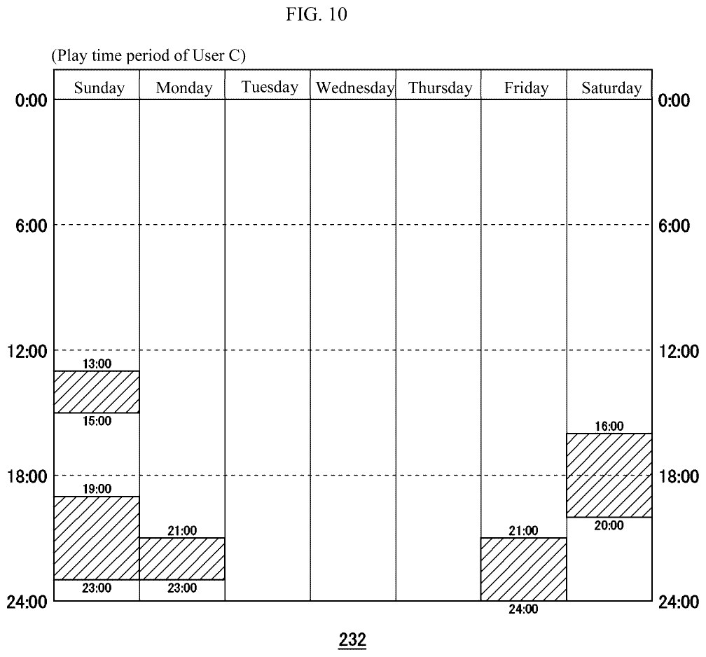

FIG. 10 shows an example of the play time period for User C. In this example, User C's play time periods may be identified as Sunday from 1:00 p.m. to 3:00 p.m., Sunday from 7:00 p.m. to 11:00 p.m., Monday from 9:00 p.m. to 11:00 p.m., Friday from 9:00 p.m. to 12:00 a.m., and Saturday from 4:00 p.m. to 8:00 p.m. Time period identification unit 216 links the identified play time periods to the user account of User C, and records this information in time information recording unit 232.

Time period identification unit 216 sums the hours of the play time period for a one-week period.

The following shows the time for each play time period.
Sunday from 1:00 p.m. to 3:00 p.m. 2 hours
Sunday from 7:00 p.m. to 11:00 p.m. 4 hours
Monday from 9:00 p.m. to 11:00 p.m. 2 hours
Friday from 9:00 p.m. to 12:00 a.m. 3 hours
Saturday from 4:00 p.m. to 8:00 p.m. 4 hours
Therefore, the total time of the play time period for this one-week period is “15 hours.” Time period identification unit 216 links the total time of User C's weekly play time period to User C's user account, and records this information in time information recording unit 232.

Relationship assessment unit 220 derives the overlap rate of the play time period based on the play time period of User A and the play time period of User C. Relationship assessment unit 220, referring to the play time period of User A shown in FIG. 8 (hereinafter referred to as “Play time period A”) and the play time period of User C shown in FIG. 10 (hereinafter referred to as “Play time period C”), derives the percentage of Play time period A that overlaps with Play time period C and the percentage of Play time period C that overlaps with Play time period A.

First, relationship assessment unit 220 calculates the time period when Play time period A and Play time period C overlap. In this example, the overlapping time periods may be calculated as follows:
Sunday from 2:00 p.m. to 3:00 p.m. 1 hour
Sunday from 7:00 p.m. to 11:00 p.m. 4 hours
Monday from 9:30 p.m. to 11:00 p.m. 1 hour 30 minutes
Friday from 10:00 p.m. to 12:00 a.m. 2 hours
Saturday from 4:00 p.m. to 8:00 p.m. 4 hours
Therefore, the total time of the overlapping time periods is “12 hours and 30 minutes.”

The percentage of the overlap of Play time period A with Play time period C may be calculated as the percentage of the total time of the overlapping time periods and the total time of Play time period A (16 hours). Therefore, relationship assessment unit 220 calculates the percentage of Play time period A that overlaps with Play time period C as 78% (=12.5/16).

For example, if the first relationship is one in which the overlap rate of two play time periods is 75% or greater, then the percentage of Play time period A that overlaps with Play time period C satisfies the first relationship. Accordingly, relationship assessment unit 220 determines that User C's play tendency is close to User A's play tendency, and that User C is a friend candidate for User A. At this time, notification unit 222 may notify User A of User C's information. More specifically, notification unit 222 may introduce User C to User A as a friend candidate. This allows User A to send a friend request to User C, who has a similar play tendency. In information processing device 10 operated by User A, friend processing unit 120 may present the information of User C that was submitted to User A, and may send a friend request to User C based on User A's operation.

The percentage of the overlap of Play time period C with Play time period A may be calculated as the percentage of the total time of the overlapping time periods and the total time of Play time period C (15 hours). Therefore, relationship assessment unit 220 calculates the percentage of Play time period C that overlaps with Play time period A as 83% (=12.5/15).

If the first relationship is one in which the overlap rate of two play time periods is 75% or greater, then the percentage of Play time period C that overlaps with Play time period A satisfies the first relationship. Accordingly, relationship assessment unit 220 determines that User A's play tendency is close to User C's play tendency, and that User A is a friend candidate for User C. At this time, notification unit 222 may notify User C of User A's information. More specifically, notification unit 222 may introduce User A to User C as a friend candidate. This allows User C to send a friend request to User A, who has a similar play tendency. In information processing device 10 operated by User C, friend processing unit 120 may present the information of User A that was submitted to User C, and may send a friend request to User A based on User C's operation.

Relationship assessment unit 220 may consider the title of the games played by each user during the play time periods in addition to the play time periods in order to determine whether the two users'play tendencies are similar. In this case, relationship assessment unit 220 determines whether the games played by each user during the play time periods satisfies the second relationship. Here, the second relationship may include that the games played during the play time periods match.

Relationship determination unit 220 reads the titles of the games played by User A and User C during the play time periods, referring to the content recorded in game title recording unit 234. Here, “Fighter2” and “Warship4” are read out as the game titles of the games played by User A. If at least one of either “Fighter2” or “Warship4” is read out as the title of the games played by User C during the play time periods, relationship assessment unit 220 determines that the games played by User A and User C during the play time periods match (e.g., are common game titles), or in other words, that the second relationship is satisfied. When relationship assessment unit 220 determines that the first relationship and the second relationship are satisfied, notification unit 222 may introduce User C to User A as a friend candidate and/or introduce User A to User C as a friend candidate. On the other hand, if relationship assessment unit 220 determines that the second relationship is not satisfied, notification unit 222 may not perform the notification process for a friend candidate.

It is also acceptable for the second relationship may include that the genres of the games played during the play time periods match. Here, the genre of the game may be a genre such as fighting or sports.

### (Case 3)

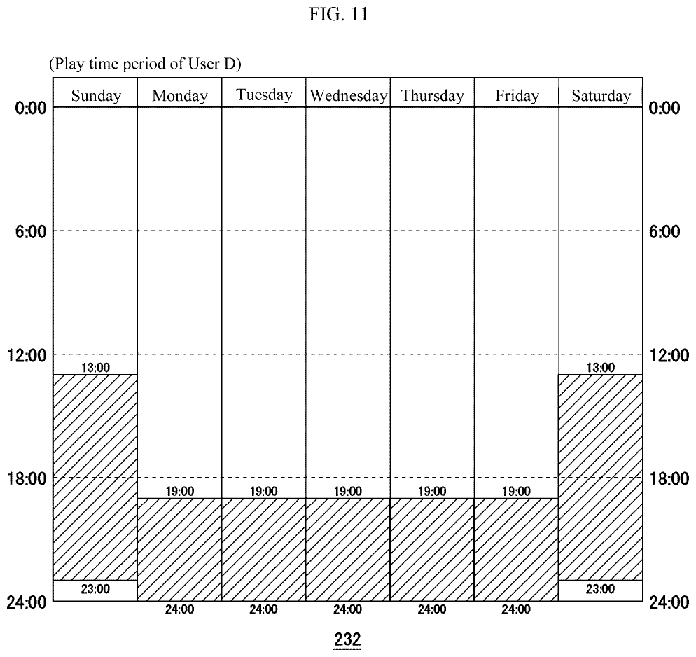

FIG. 11 shows an example of the play time period for User D. In this example, User D's play time periods may be identified as Sunday from 1:00 p.m. to 11:00 p.m., Monday from 7:00 p.m. to 12:00 a.m., Tuesday from 7:00 p.m. to 12:00 a.m., Wednesday from 7:00 p.m. to 12:00 a.m., Thursday from 7:00 p.m. to 12:00 a.m., Friday from 7:00 p.m. to 12:00 a.m., and Saturday from 1:00 p.m. to 11:00 p.m. Time period identification unit 216 links the identified play time periods to the user account of User D, and records this information in time information recording unit 232.

Time period identification unit 216 sums the hours of the play time period for a one-week period.

The following shows the time for each play time period.
Sunday from 1:00 p.m. to 11:00 p.m. 10 hours
Monday from 7:00 p.m. to 12:00 a.m. 5 hours
Tuesday from 7:00 p.m. to 12:00 a.m. 5 hours
Wednesday from 7:00 p.m. to 12:00 a.m. 5 hours
Thursday from 7:00 p.m. to 12:00 a.m. 5 hours
Friday from 7:00 p.m. to 12:00 a.m. 5 hours
Saturday from 1:00 p.m. to 11:00 p.m. 10 hours
Therefore, the total time of the play time period for this one-week period is “45 hours.” Time period identification unit 216 links the total time of User D's weekly play time period to User D's user account, and records this information in time information recording unit 232.

Relationship assessment unit 220 derives the overlap rate of the play time period based on the play time period of User A and the play time period of User D. Relationship assessment unit 220, referring to the play time period of User A shown in FIG. 8 (hereinafter referred to as “Play time period A”) and the play time period of User D shown in FIG. 11 (hereinafter referred to as “Play time period D”), derives the percentage of Play time period A that overlaps with Play time period D and the percentage of Play time period D that overlaps with Play time period A.

First, relationship assessment unit 220 calculates the time period when Play time period A and Play time period D overlap. In this example, the overlapping time periods may be calculated as follows:
Sunday from 2:00 p.m. to 3:00 p.m. 1 hour
Sunday from 6:00 p.m. to 11:00 p.m. 5 hours
Monday from 9:30 p.m. to 11:00 p.m. 1 hour 30 minutes
Friday from 10:00 p.m. to 12:00 a.m. 2 hours
Saturday from 03:30 p.m. to 10:00 p.m. 4 hours 30 minutes
Therefore, the total time of the overlapping time periods is “14 hours.”

The percentage of the overlap of Play time period A with Play time period D may be calculated as the percentage of the total time of the overlapping time periods and the total time of Play time period A (16 hours). Therefore, relationship assessment unit 220 calculates the percentage of Play time period A that overlaps with Play time period D as 88% (=14/16).

If the first relationship is one in which the overlap rate of two play time periods is 75% or greater, then the percentage of Play time period A that overlaps with Play time period D satisfies the first relationship. Accordingly, relationship assessment unit 220 determines that User D's play tendency is close to User A's play tendency, and that User D is a friend candidate for User A. At this time, notification unit 222 may notify User A of User D's information. More specifically, notification unit 222 may introduce User D to User A as a friend candidate. This allows User A to send a friend request to User D, who has a similar play tendency.

The percentage of the overlap of Play time period D with Play time period A may be calculated as the percentage of the total time of the overlapping time periods and the total time of Play time period D (45 hours). Therefore, relationship assessment unit 220 calculates the percentage of Play time period D that overlaps with Play time period A as 31% (=14/45).

If the first relationship is one in which the overlap rate of two play time periods is 75% or greater, then the percentage of Play time period D that overlaps with Play time period A does not satisfy the first relationship. Accordingly, relationship assessment unit 220 determines that User A's play tendency is different from User D's play tendency, and that User A is not a friend candidate for User D. Therefore, notification unit 222 will not notify the User D of the information of User A.

If the total time of the two user play time periods differs greatly in this way, the overlap rate of each derived play time period will differ greatly. In the example of Case 3, relationship assessment unit 220 determines that User D's play tendency is close to User A's play tendency, while User A's play tendency is different from User D's play tendency. In order to avoid this type of situation, relationship assessment unit 220 may consider the total time of the play time periods in a one-week period for user in addition to the play time periods in order to determine whether the play tendencies of the two users are similar. Relationship assessment unit 220 determines whether the total time of each user's play time periods satisfies the third relationship. The third relationship may be the proximity of each total time.

When the total time of the play time periods of User A in a one-week week period is treated as Ta, and the total time of the play time periods of User D in a one-week period is treated as Td, the third relationship may be expressed using the following relationship equation:

$$t 1 \leq Ta / Td \leq 1 / t 1$$

Here, t1 is a positive value of less than 1. For example, it is preferable for t1 to be ⅔ or more. Relationship assessment unit 220 determines that, when Ta and Td satisfy this relationship expression, the third relationship is satisfied.

Here, Ta/Td is 16/45. When t1 is 4/5,

$$t 1 > Ta / Td$$

and the relationship is not satisfied. Therefore, relationship assessment unit 220 may determine that each total time of the play time periods in the one-week period does not satisfy the third relationship, and may determine that User D's play tendency differs from User A's play tendency, and that User A's play tendency differs from User D's play tendency.

In the example of Case 2, the total time Ta of User A's weekly play time period is 16 hours, and the total time Tc of User C's weekly play time period is 15 hours. Therefore, when t1 is 4/5, the relationship

$$t 1 \leq Ta / Tc \leq 1 / t 1$$

may be established. Relationship assessment unit 220 may therefore determine that each total time of the play time periods in the one-week period satisfies the third relationship, and may determine that User C's play tendency is close to User A's play tendency, and that User A's play tendency is close to User C's play tendency. At this time, notification unit 222 may introduce User C as a friend candidate to User A and/or introduce User A as a friend candidate to User C.

As described above, profile information provision unit 224 provides the play tendency information of a user to information processing device 10 as part of the profile information. In information processing device 10, profile information acquisition unit 116 acquires the play tendency information as part of the profile information. Profile image generation unit 118 generates a profile image that includes the play tendency information, and display processing unit 122 displays the profile screen on output device 4.

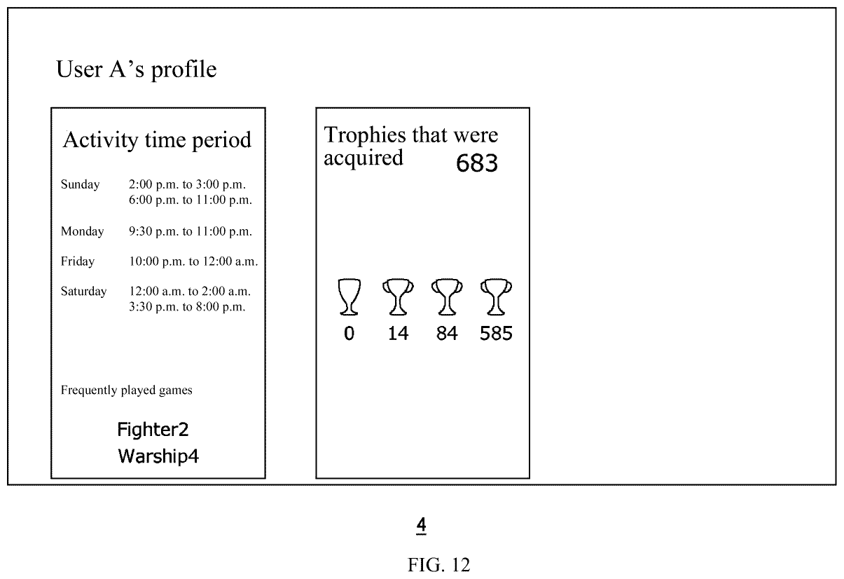

FIG. 12 shows an example of the profile screen. This profile screen includes at least the play tendency information about User A. In this example, display processing unit 122 displays a profile screen that includes User A's activity time periods (play time periods), the titles of the games that User A often plays, and the number of trophies that User A has acquired. Of this information, the activity time period and the title of the games that User A frequently plays represent the play tendency information generated in server device 5 using the past game start-up information and game end information of User A.

For example, when User C receives a friend request from User A, User C may view the profile screen of User A to check User A's play tendencies. By checking the User A's play tendency, User C is able to make a decision whether or not to permit the friend request. It should be noted that, even when User A is referred to User C by server device 5 as a friend candidate, by viewing the profile screen of User C, it may be possible for User A to confirm the play tendency of User C, and for User A to decide whether or not to send a friend request. Preferably, the privacy settings of the user will determine whether or not the play tendency information may be included on the profile screen. Users may customize privacy settings to determine whether their play tendency information is displayed on their profile screen, allowing for selective sharing of activity data.

The present disclosure has been described above based on the examples of embodiment. The above-noted examples of embodiment are illustrative, and it will be understood by those skilled in the art that various modifications are possible with regard to combinations of the various components and various types of processing, and that such modified examples are also within the scope of the present disclosure. In the example of embodiment, although individual user-to-user matching has been described, the present disclosure may also be applied to multi-person collective parties or events and community-to-community matching. The disclosed technology may be extended to match groups of users or entire communities based on aggregated play tendency information, thereby supporting multi-player team formation and broader community engagement such as community events.

In the example of embodiment, notification unit 222 was described as notifying the user of the matched player as a potential friend. Notification unit 222 may also notify the matched player as a friend candidate at a predetermined timing. For example, notification unit 222 may periodically notify the user of potential friends, and it may also notify the user of a potential friend when notifying the user of any other information. In some embodiments, notification of friend candidates may occur in response to user requests, at scheduled intervals, or when other relevant information is presented to the user, such as updates to their profile or game achievements.

Also, notification unit 222 may notify the user of a matched player as a friend candidate in response to the user sending a request to obtain a friend candidate to server device 5. In this way, notification unit 222 may perform notification processing of a friend candidate in response to a request for acquisition from a user. This type of notification of potential friends may be made, for example, by highlighting the player name in the player list.

### INDUSTRIAL APPLICABILITY

The present disclosure may be utilized in technology to match users.

### REFERENCE SIGNS LIST

1 . . . Information processing system, 5 . . . Server device, 10 . . . Information processing unit, 100 . . . Processing unit, 102 . . . Communication unit, 108 . . . Reception unit, 110 . . . Game execution unit, 112 . . . Execution information acquisition unit, 114 . . . Game image generation unit, 116 . . . Profile information acquisition unit, 118 . . . Profile image generation unit, 120 . . . Friend processing unit, 122 . . . Display processing unit, 124 . . . Transmission processing unit, 200 . . . Processing unit, 202 . . . Communication unit, 210 . . . Execution information acquisition unit, 212 . . . Play date and time identification unit, 214 . . . Play probability derivation unit, 216 . . . Time period identification unit, 218 . . . Game title identification unit, 220 . . . Relationship assessment unit, 222 . . . Notification unit, 224 . . . Profile information provision unit, 230 . . . Execution information recording unit, 232 . . . Time information recording unit, 234 . . . Game title recording unit

What is claimed is:

1. A server device that is provided comprising one or more processors having hardware configured to perform operations comprising:
acquiring game start-up information indicating that a plurality of users have launched a game;
acquiring game end information indicating that the plurality of users have terminated the game;
identifying play time periods associated with each of the plurality of users plays the game based at least in part on the game start-up information and the game end information; and
identifying at least two users whose play time periods satisfy a first relationship.

2. The server device of claim 1, wherein the operations comprise:
notifying at least one of the at least two users whose play time periods satisfy the first relationship.

3. The server device of claim 2, wherein the operations comprise:
referring the at least one user of the at least two users to the other of the at least two users as a friend candidate.

4. The server device of claim 2, wherein the operations comprise:
identifying games played by each of the plurality of users based at least in part on the game start-up information and game end information; and
notifying at least one of the at least two users whose games played satisfy a second relationship.

5. The server device of claim 2, wherein the operations comprise:
identifying a total time of the play time periods during a one-week period for each of the plurality of users based at least in part on the game start-up information and the game end information; and
notifying at least one of the at least two users whose total time for the play time periods in the one-week period satisfies a third relationship.

6. The server device of claim 1, wherein the operations further comprise:
acquiring user operation information from an input device associated with each of the plurality of users.

7. The server device of claim 1, wherein the operations further comprise:
storing the game start-up information and the game end information in an execution information recording unit linked to a user account.

8. The server device of claim 1, wherein the first relationship is defined by a predetermined threshold of overlap in play time periods between two users.

9. The server device of claim 1, wherein the operations further comprise:
identifying a probability that a user plays a game during a particular time slot based on historical play data.

10. The server device of claim 9, wherein the probability is calculated over a defined analysis period comprising multiple weeks.

11. The server device of claim 1, wherein the operations further comprise:
identifying, for each user, game titles that are played during the play time periods.

12. The server device of claim 11, wherein the operations further comprise:
determining whether two users have played at least one common game title during overlapping play time periods.

13. The server device of claim 1, wherein the operations further comprise:
identifying a genre of games played during the play time periods; and
notifying users whose play time periods and game genres match.

14. The server device of claim 1, wherein the operations further comprise:
periodically updating the identified play time periods and play tendency information based on newly acquired game start-up and end information.

15. The server device of claim 1, wherein the operations further comprise:
enabling users to customize privacy settings for sharing play tendency information on their profile screens.

16. The server device of claim 1, wherein the operations further comprise:
supporting matching and notification for multiple users forming a group or community based on aggregated play tendency information.

17. The server device of claim 1, wherein the operations further comprise:
providing a recommendation to users to form a group or participate in a community event based on matched play time periods.

18. An information processing device that is provided with one or more processors having hardware configured to perform operations comprising:
acquiring a user's play tendency information generated based at least in part on past game start-up information and game end information; and
displaying a profile screen comprising the play tendency information, wherein the play tendency information comprises information indicating a time period during which the user is playing a game.

19. The information processing device of claim 18, wherein the profile screen further comprises: an indication of titles of games most frequently played by the user.

20. The information processing device of claim 18, wherein the profile screen further comprises: an indication of achievements or virtual rewards acquired by the user during gameplay.
